(19) United States
(12) Patent Application Publication
(10) Pub. No.: US 2015/0254023 A1
(43) Pub. Date: Sep. 10, 2015

(54) METHOD FOR STORING AND RETRIEVING HARDWARE SYSTEM DATA

(71) Applicant: Panasonic Automotive Systems Company of America, Division of Panasonic Corporation of North America, Peachtree City, GA (US)

(72) Inventor: GERALD C. DAVIS, FAYETTEVILLE, GA (US)

(73) Assignee: Panasonic Automotive Systems Company of America, Division of Panasonic Corporation of North America, Peachtree City, GA (US)

(21) Appl. No.: 14/199,106

(22) Filed: Mar. 6, 2014

(51) Int. Cl. G06F 3/06; G06F 13/38

(52) U.S. Cl. CPC G06F 3/0679; G06F 13/385; G06F 3/0604; G06F 3/0655

(57) ABSTRACT

A hardware system data retrieval arrangement includes a printed circuit board having a memory device connected to a microcontroller. The memory device stores historical information about the printed circuit board. A connecting device is connected to the microcontroller. The connecting device includes a Universal Serial Bus connector or an edge card connector. An electrical communication conduit interconnects the personal computer and the connecting device. The personal computer retrieves the historical information form the memory device via the electrical communication conduit.

### BACKGROUND OF THE INVENTION

1. Field of the Invention

The present invention relates to retrieving hardware system data, and, more particularly, to retrieving hardware system data in an automotive environment.

2. Description of the Related Art

Identifying information and other pertinent information about a printed circuit board and the hardware thereon is often recorded for future use in case the circuit board ever needs to be serviced. Some manufacturers typically store limited information such as a serial number, manufacturing date, etc. about the hardware in a barcode printed on the printed circuit board. A barcode reader is used to scan this barcode and then pulls up the configuration data for the printed circuit board or hardware. This method does not allow changes to be stored locally (e.g., on the printed circuit board) and requires access to a database to recall information about the hardware.

### SUMMARY OF THE INVENTION

The invention may include a universal serial bus (USB) cable connected to a printed circuit board. The USB cable may provide power to and a communication path from a personal computer (PC) to an embedded microcontroller on the target hardware. The target hardware may have a non-volatile means (e.g., a EEPROM) of storing data related to hardware system performance and internal diagnostics, providing a convenient way to read these data during development and/or future repair. Software running on the PC may detect and read the data stored on the EEPROM, and log information about the diagnostic session. The user can add or modify notes about any changes or upgrades made to the hardware.

This invention provides a simple way to read and write data about the hardware and avoids having to make notes on the board surface (e.g., using a permanent marker) or on tags tied to the board used for development or for repairs. All information may be stored electronically and the information may be kept on the board to prevent loss of information or confusion about the status of the hardware. The USB connection may provide enough power for the microcontroller and the EEPROM on the board for operation in order to retrieve and/or store new data to the EEPROM without plugging in additional cables or power supplies.

The invention comprises, in one form thereof, a hardware system data retrieval arrangement including a printed circuit board having a memory device connected to a microcontroller. The memory device stores historical information about the printed circuit board. A connecting device is connected to the microcontroller. The connecting device includes a Universal Serial Bus connector or an edge card connector. An electrical communication conduit interconnects a computing device and the connecting device. The computing device retrieves the historical information from the memory device via the electrical communication conduit.

The invention comprises, in another form thereof, a hardware system data retrieval arrangement including a printed circuit board having a memory device storing historical information about the printed circuit board, and a connecting device connected to the memory device. A Universal Serial Bus dongle is connected to the connecting device. An electrical communication conduit interconnects a computing device and the dongle. The computing device retrieves the historical information from the memory device via the electrical communication conduit.

The invention comprises, in yet another form thereof, a hardware system data retrieval arrangement including a printed circuit board having an embedded Universal Serial Bus flash memory device storing historical information about the printed circuit board, and a first connecting device connected to the flash memory device. The first connecting device includes a first header or a first edge card connector. A second connecting device is connected to the flash memory device. The second connecting device includes a second header or a second edge card connector. An electrical communication conduit interconnects a computing device and the second connecting device. The computing device retrieves the historical information from the flash memory device via the electrical communication conduit.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a hardware system data retrieval arrangement of the present invention.

FIG. 2 is a block diagram of another embodiment of a hardware system data retrieval arrangement of the present invention.

FIG. 3 is a block diagram of yet another embodiment of a hardware system data retrieval arrangement of the present invention.

FIG. 4 is a block diagram of still another embodiment of a hardware system data retrieval arrangement of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

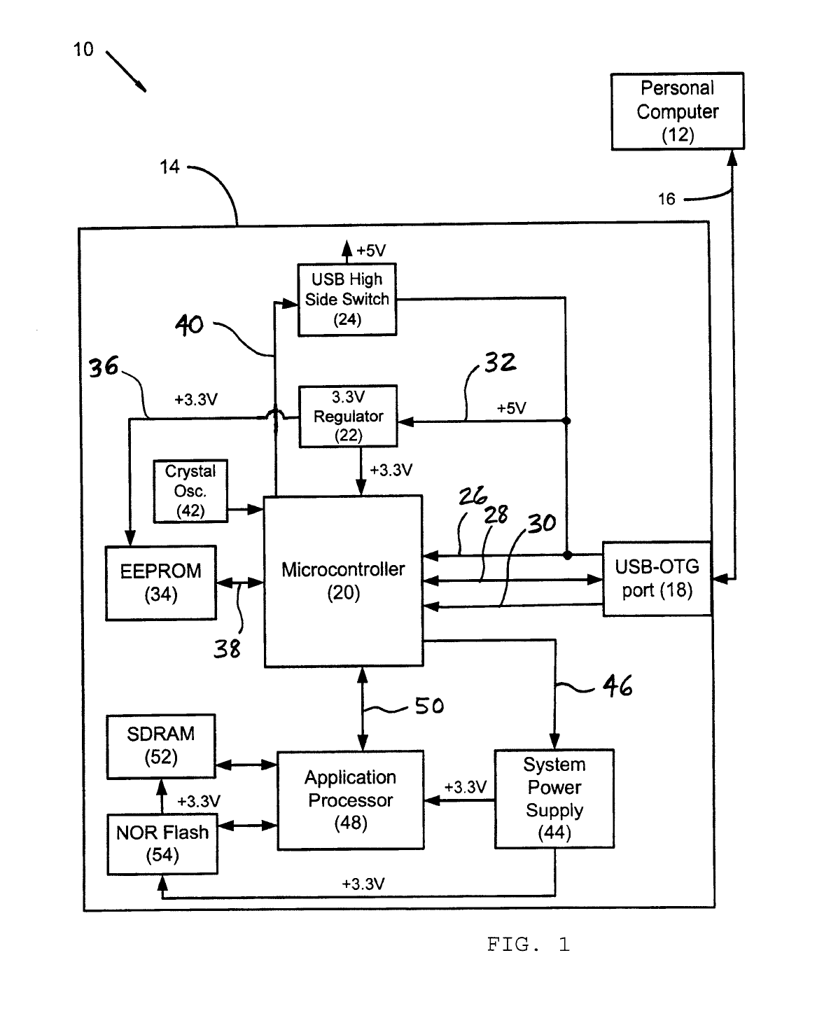

FIG. 1 is an exploded view illustrating one embodiment of a hardware system data retrieval arrangement 10 of the present invention. Arrangement 10 may be included in a motor vehicle, and particularly in an audio system of a motor vehicle, for example. Arrangement 10 includes a computing device in the form of a personal computer (PC) 12 connected to a printed circuit board 14 via a USB cable 16. Printed circuit board 14 includes an electrical USB connector in the form of a USB-OTG (On-The-Go) port 18, which may be connected to USB cable 16. Alternatively, the USB connector may be in the form of a USB device mode port. Port 18 is connected to a low power microcontroller 20, a 3.3 Volt regulator 22, and an optional USB high side switch 24, which may be current limited. Port 18 may be connected to microcontroller 20 via a VBUS detection line 26, a USB line 28, and an identification line 30.

Port 18 may provide 5 Volts to regulator 22 via power line 32. Regulator 22, in turn, may provide 3.3 Volts to an electrically erasable programmable read only memory (EEPROM) memory device 34 via a line 36. Memory device 34 may store and contain identifying information and pertinent historical information about a printed circuit board and the hardware thereon. For example, the historical information may include service records such as manufacturing dates, servicing dates, services performed, and hardware replaced on printed circuit board 14.

Microcontroller 20 may be connected to EEPROM 34 via a Serial-Peripheral interface (SPI) or Inter Integrated Circuit Communications (I2C) line 38. Microcontroller 20 may be connected to switch 24 via a VBUS_EN line 40. Microcontroller 20 may receive inputs from a crystal oscillator 42. Microcontroller 20 may be connected to a system power supply 44 via a line 46. Microcontroller 20 may be connected to an application processor 48 via an inter-processor communication bus 50. Bus 50 may be in the form of a serial peripheral interface (SPI) bus, a universal asynchronous receiver/transmitter (UART) or USB cable. Processor 48 may be normally powered down and may typically draw high power (e.g., more than 2.5 Watts).

Processor 48 may be in bi-directional communication with both a synchronous dynamic random access memory (SDRAM) memory 52 and a NOR a flash memory 54. Power supply 44 may provide voltage (e.g., 3.3 Volts) to both processor 48 and NOR flash memory 54. Memory 54, in turn, may provide 3.3 Volts to SDRAM memory 52.

USB typically supplies up to 500 mA at 5V (2.5 W) to power any circuitry on the board. This may be more than enough to power a typical microcontroller which can communicate with a EEPROM. The system may typically include a microcontroller and EEPROM and a USB port for communication. USB OTG or another device may be used to communicate with the PC.

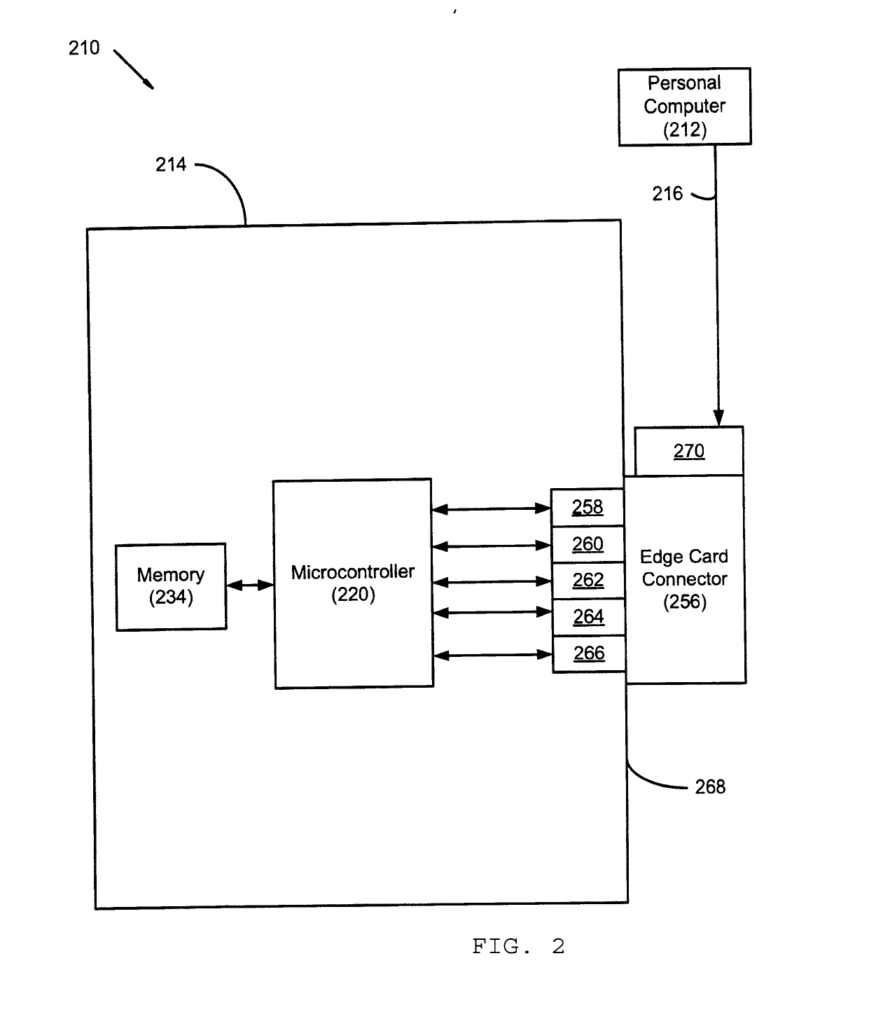

FIG. 2 illustrates another embodiment of a hardware system data retrieval arrangement 210 of the present invention. Printed circuit board 214 does not include a USB connector, and may include an electrical connector in the form of an edge card connector 256 instead of a USB connector. Five fingers 258, 260, 262, 264, 266 disposed on an edge 268 of printed circuit board 214 may enable edge card connector 256 to mate with printed circuit board 214 with the following standard USB signals: 1. VBUS (+5V), 2. D+, 3. D−, 4. GND, and 5. ID. Thus, edge card connector 256 may be connected to microcontroller 220, which in turn may be connected to memory device 34. A USB-to-edge card connector adapter 270 may connect printed circuit board 214 to USB cable 216 and PC 212. Thus, this embodiment may have the advantage of not burdening the printed circuit board with the cost of a USB connector. Memory device 234 may store and contain identifying information and pertinent historical information about a printed circuit board and the hardware thereon. For example, the historical information may include service records such as manufacturing dates, servicing dates, services performed, and hardware replaced on printed circuit board 214.

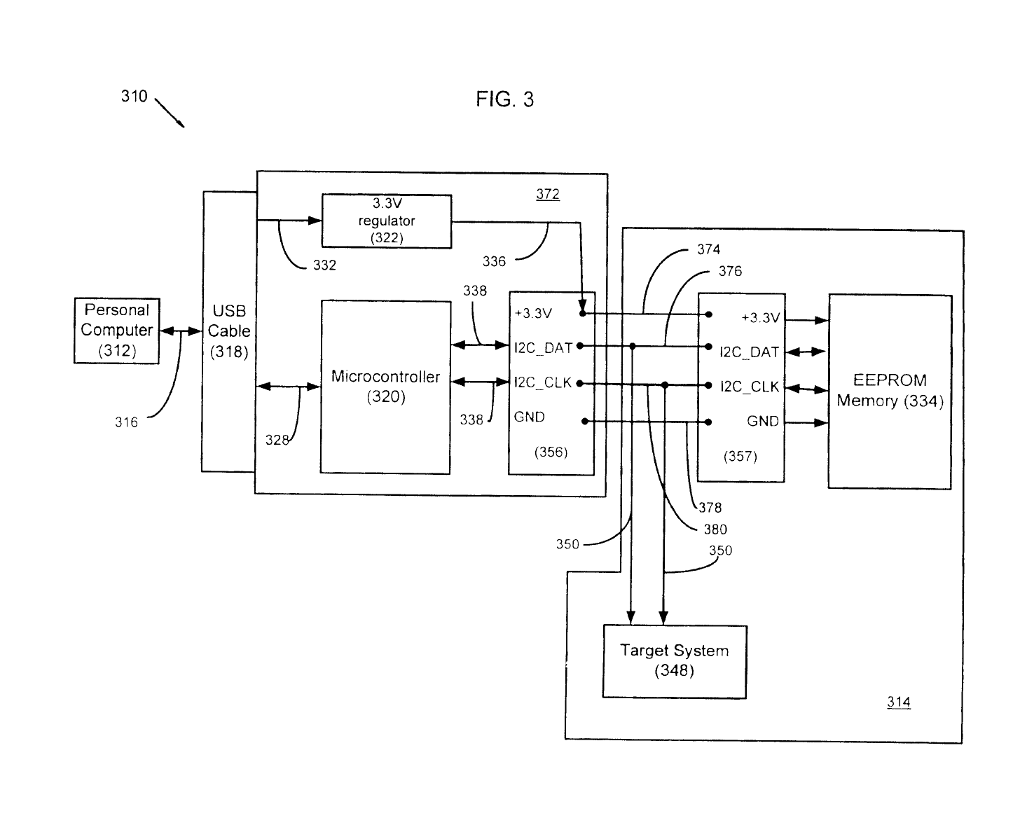

FIG. 3 illustrates yet another embodiment of a hardware system data retrieval arrangement 310 of the present invention. Arrangement 310 includes a personal computer (PC) 312 connected to a printed circuit board 314 via a USB cable 316, an optional USB connector 318, and a USB dongle 372. Dongle 372 may include an integrated microcontroller 320 with a SPI or I2C communication port 338 to communicate with an EEPROM memory 334 on printed circuit board 314 via connected edge card connectors 356, 357 on dongle 372 and printed circuit board 314, respectively. Edge card connectors 356, 357 may be connected via a 3.3 Volt line 374, an I2C_DAT line 376, an I2C_CLK line 378, and a GND line 380. Alternatively, edge card connectors 356, 357 may be replaced by headers.

USB connector 318 is connected to microcontroller 320 via a USB line 328, and to a 3.3 Volt regulator 322 via a 5 Volt power line 332. Regulator 322, in turn, may provide 3.3 Volts to connector 356 via a line 336.

Printed circuit board 314 may include a target system 348 which may be connected to edge card connectors 356, 357 via an optional communication bus 350. Particularly, bus 350 may connect target system 348 to I2C_DAT line 376 and I2C_CLK line 378. Target system 348 may be normally powered off, may not be powered or enabled by USB dongle 372.

The integrated microcontroller 320 may act as a bridge between USB bus 328 and the SPI or I2C protocol communication port 338 to enable PC 312 to communicate with EEPROM 334. EEPROM 334 may store and contain identifying information and pertinent historical information about a printed circuit board and the hardware thereon. For example, the historical information may include service records such as manufacturing dates, servicing dates, services performed, and hardware replaced on printed circuit board 314.

This embodiment may have the advantage of requiring only an EEPROM on board 314 and power supplied by the edge card connector adapter 357. In this embodiment, dongle 372 may be used to communicate with board 314 instead of using a USB cable. Communication with the rest of the system could be enabled via a I2C or SPI bus. Alternatively, it is possible for the EEPROM to be separate from the rest of the system so that the EEPROM is used for storing and retrieving user data about the hardware without communicating with the rest of the system.

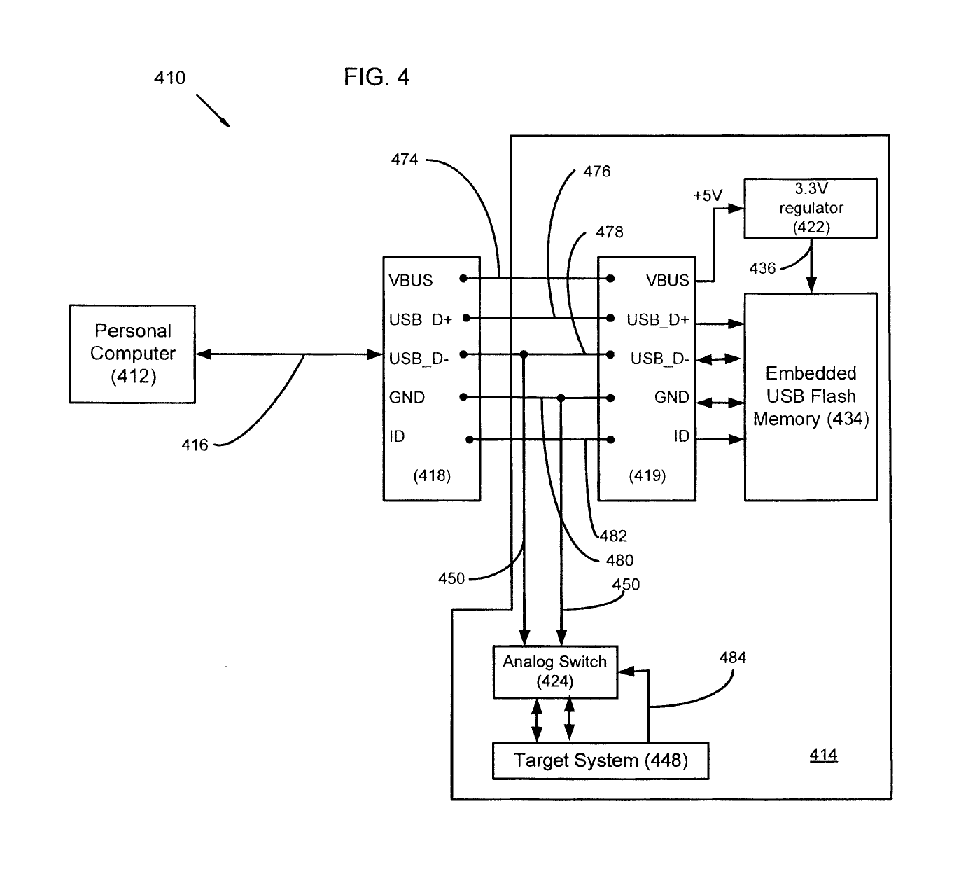

FIG. 4 illustrates still another embodiment of a hardware system data retrieval arrangement 410 of the present invention. Arrangement 410 includes a USB host in the form of a personal computer (PC) 412 connected to a printed circuit board 414 via a USB cable 416, and a USB connector 418. Printed circuit board 414 may include a USB connector 419 enabling communication between USB connector 418 and an embedded USB flash memory module 434 on printed circuit board 414. Memory module 434 may store and contain identifying information and pertinent historical information about a printed circuit board and the hardware thereon. For example, the historical information may include service records such as manufacturing dates, servicing dates, services performed, and hardware replaced on printed circuit board 414.

USB connectors 418, 419 may be connected via a VBUS line 474, a USB_D+ line 476, a USB_D− line 478, a GND line 480, and an ID line 482. Alternatively, USB connectors 418, 419 may be replaced by edge card connectors.

USB connector 419 is connected to a 3.3 Volt regulator 422 via a 5 Volt power line 432. Regulator 422, in turn, may provide 3.3 Volts to memory 434 via a line 436.

Printed circuit board 414 may include a target system 448 which may be connected to USB connectors 418, 419 via a normally open analog switch 424 and an optional communication bus 450. Particularly, bus 450 may connect analog switch 424 to USB_D+ line 476 and USB_D− line 478. Target system 448 may be normally powered off, and may enable switch 424 via line 484.

This embodiment may have the advantage of not requiring a microcontroller on the board nor a dongle. Some modules may be powered directly from the +5V VBUS power via the USB cable.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A hardware system data retrieval arrangement comprising:
a printed circuit board including:
a microcontroller;
a memory device connected to the microcontroller, the memory device storing historical information about the printed circuit board; and
a connecting device connected to the microcontroller, the connecting device comprising a Universal Serial Bus connector or an edge card connector; and
a computing device; and
an electrical communication conduit interconnecting the computing device and the connecting device, wherein the computing device is configured to retrieve the historical information from the memory device via the electrical communication conduit.

2. The arrangement of claim 1 wherein the connecting device comprises a Universal Serial Bus-On-The-Go port.

3. The arrangement of claim 1 wherein the connecting device comprises an edge card connector.

4. The arrangement of claim 3 further comprising a Universal Serial Bus-to-edge card connector adapter interconnecting the edge card connector and the electrical communication conduit.

5. The arrangement of claim 1 wherein the electrical communication conduit comprises a Universal Serial Bus cable.

6. The arrangement of claim 1 wherein the connecting device comprises a Universal Serial Bus device mode port.

7. The arrangement of claim 1 wherein the memory device comprises an EEPROM.

8. A hardware system data retrieval arrangement comprising:
a printed circuit board including:
a memory device storing historical information about the printed circuit board; and
a connecting device connected to the memory device;
a Universal Serial Bus dongle connected to the connecting device;
a computing device; and
an electrical communication conduit interconnecting the computing device and the dongle, wherein the computing device is configured to retrieve the historical information from the memory device via the electrical communication conduit.

9. The arrangement of claim 8 wherein the connecting device comprises a header or an edge card connector.

10. The arrangement of claim 9 wherein the dongle comprises a header or an edge card connector.

11. The arrangement of claim 8 further comprising a Universal Serial Bus connector interconnecting the electrical communication conduit and the dongle.

12. The arrangement of claim 8 wherein the electrical communication conduit comprises a Universal Serial Bus cable.

13. The arrangement of claim 8 wherein the dongle includes an integrated microcontroller having an I2C communication port.

14. The arrangement of claim 8 wherein the memory device comprises an EEPROM.

15. A hardware system data retrieval arrangement comprising:
a printed circuit board including:
an embedded Universal Serial Bus flash memory device storing historical information about the printed circuit board; and
a first connecting device connected to the flash memory device, the first connecting device comprising a first header or a first edge card connector;
a second connecting device connected to the flash memory device, the second connecting device comprising a second header or a second edge card connector;
a computing device; and
an electrical communication conduit interconnecting the computing device and the second connecting device, wherein the computing device is configured to retrieve the historical information from the flash memory device via the electrical communication conduit.

16. The arrangement of claim 15 wherein the electrical communication conduit comprises a Universal Serial Bus cable.

17. The arrangement of claim 15 wherein the computing device comprises a personal computer.

18. The arrangement of claim 15 wherein the printed circuit board includes a target system connected to the first connecting device.

19. The arrangement of claim 18 wherein the printed circuit board includes an analog switch interconnecting the target system and the first connecting device.

20. The arrangement of claim 19 wherein the target system is configured to enable the analog switch.
